(19) United States
(12) Patent Application Publication
(10) Pub. No.: US 2008/0276782 A1
(43) Pub. Date: Nov. 13, 2008

(54) MULTI-CUTTER

(76) Inventors: Carol Senkalski, Eric, PA (US); Tamara Mononsoff, Walnut Creek, CA (US)

Correspondence Address: WEST & ASSOCIATES, A PC, 2815 MITCHELL DRIVE, SUITE 209, WALNUT CREEK, CA, 94598, US

(21) Appl. No.: 12/119,473

(22) Filed: May 12, 2008

Related U.S. Application Data
(60) Provisional application No. 60/917,615, filed on May 11, 2007.

(51) Int. Cl. B26F 1/14; A47J 43/00

(52) U.S. Cl. 83/684; 99/537

(57) ABSTRACT

An apparatus to quickly and uniformly cut out cookies and to cut out multiple cookie shapes in just a fraction of the time that it once took using Conventional cookie cutters that only cut one cookie at a time.

### CLAIM OF PRIORITY

The present application claims the benefit of priority of prior-filed U.S. Provisional Patent Application Ser. No. 60/917,615, filed May 11, 2007, the complete contents of which is hereby incorporated herein by reference.

### BACKGROUND

This patent application relates, generally, kitchen gadgets and more specifically to apparatus for cookie cutting.

People spend an exorbitant amount of time and energy to cut out hundreds of very small cookies. Hence, many people find the slow process of making shaped cookies to be daunting due to the time commitment. This is especially true for those people who either work full-time jobs or those who do lots of baking for the holidays.

Regular cookie cutters are much too big for the job. Small cutters sold in the craft stores to cut clay are a great size, but they take too much time for this size job. Using a knife and a rolling pizza cutter, still takes too long and the pieces end up being multi-sized and do not bake evenly. Also using a julienne slicer for potatoes, the frame around it ends up smashing the cookie dough.

What is needed is an apparatus which will allow a user to quickly and uniformly cut out multiple cookies and to cut out multiple cookie shapes in just a fraction of the time that it once took using conventional cookie cutters that only cut one cookie at a time.

### BRIEF DESCRIPTION OF THE DRAWINGS

FIG. 1 depicts one embodiment of a Multi-Cutter.

FIG. 2 depicts an alternate embodiment of the Multi-Cutter shown in FIG. 1.

FIG. 3 depicts an alternate embodiment of the Multi-Cutter shown in FIG. 1.

FIG. 4 depicts an alternate embodiment of the Multi-Cutter shown in FIG. 1.

FIG. 5 depicts an alternate embodiment of the Multi-Cutter shown in FIG. 1.

FIG. 6 depicts an alternate embodiment of the Multi-Cutter shown in FIG. 1.

FIG. 7-FIG. 14 depicts an alternate embodiment of the Multi-Cutter shown in FIG. 1.

FIG. 15 depicts an alternate embodiment of the Multi-Cutter shown in FIG. 1.

FIG. 16 depicts an alternate embodiment of the Multi-Cutter shown in FIG. 1.

FIG. 17-FIG. 25 depicts an alternate embodiment of the Multi-Cutter shown in FIG. 1.

### DETAILED DESCRIPTION

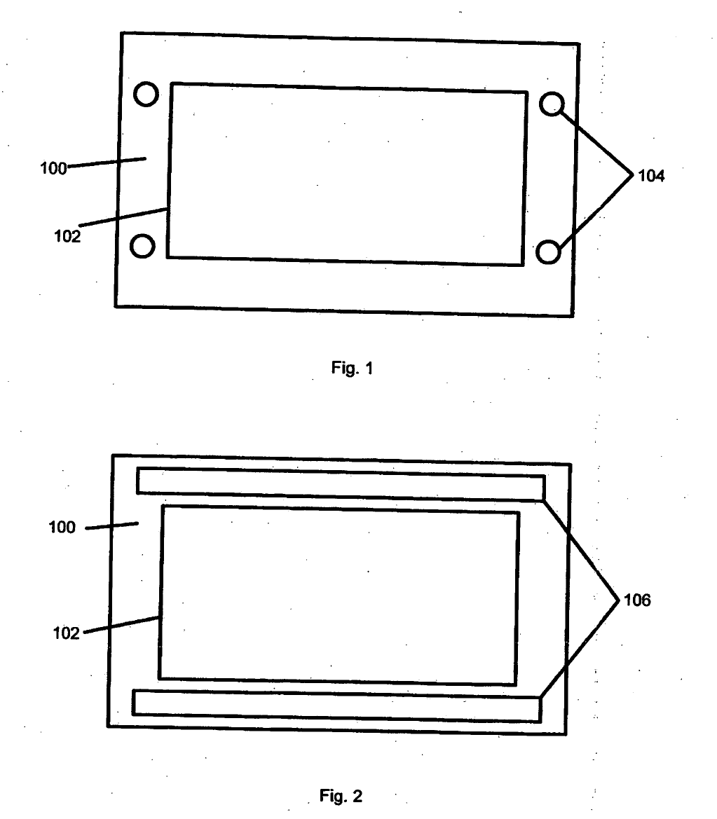

FIG. 1 depicts the top view of the Multi-Cutter. FIG. 1 shows the frame 100 of the Multi-Cutter. The Multi-Cutter can be made-up of three components: a frame 100, a cutter assembly 408, and a plunger attachment 2100.

FIG. 1 depicts an embodiment in which the Frame can be made using a Wood frame 100 8″×941 with a cutout interior 102 measuring 6″×7″. However in alternate embodiments, the Frame 100 can be comprised of any other known and/or convenient material and can have any known and/or convenient dimensions. This cutout 102 area can allow the user to look down and see exactly where the cutter 800 could be placed on the dough. In some embodiments, the top of the frame 100 can include 4 posts/dowels 104 capable of holding a plunger attachment 2100. These posts 104 can be placed 1⅜″ in from the 9″ side of the frame 100 and ½″ in from the 8″ side of the frame 100. However, in alternate embodiments any convenient number of posts/dowels 104 can be used and such posts 104 can be located in any convenient geometric relationship to the frame 100. In some embodiments, each post 104 can have a 1″ spring 2200 on it to hold up the plunger attachment 2100. However, in alternate embodiments, a spring of any convenient dimension and/or the springs may not be present.

FIG. 2 depicts the bottom view of an embodiment. The underside of the frame 100 can include two pieces of 8″ long aluminum ¼″ channel 106, that can be placed along the long side of the frame 100, the 9″ side. This channel 106 can be attached ¼″ from inside edge of the frame. This can be the channel 106 for a cutter assembly 408 to slide into. Thus in some embodiments, the cutter assembly 408 could be 6⅛″ wide—to correctly mate with the frame 100. However, in alternate embodiments any dimensions and/or geometric relationship which will allow the components to mate correctly can be used. Moreover, in alternate embodiments, any convenient number of channels 106 can be used and such channels 106 can be placed in any convenient geometric relationship to the frame 100 and such channels 106 can be made of any known and/or convenient material.

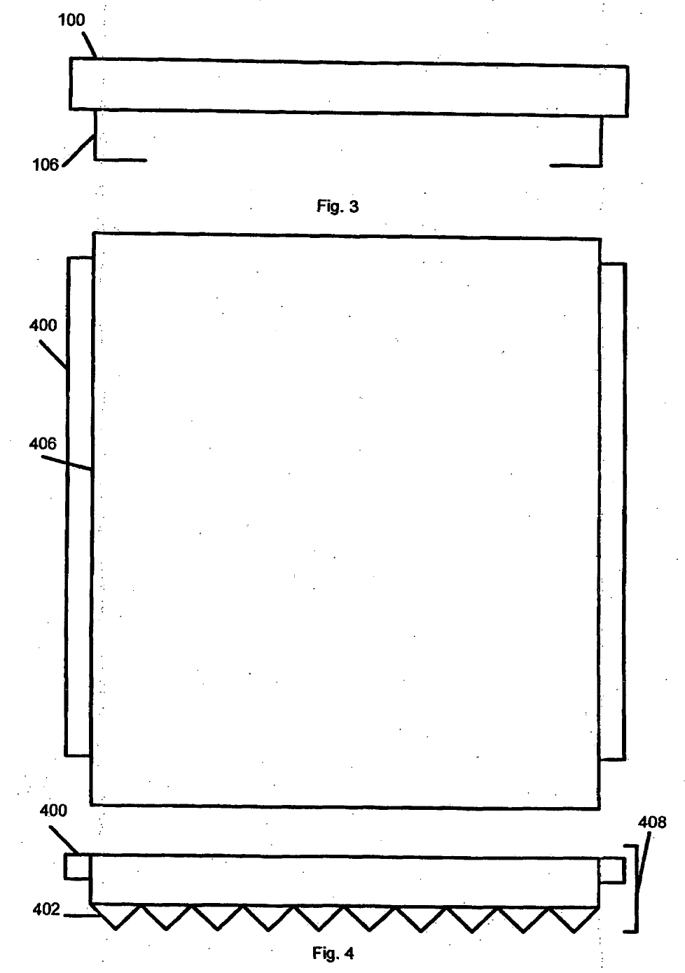

FIG. 3 depicts a side view of the Multi-Cutter. The channels 106 are shown attached to the frame 100.

FIG. 4 shows a top view and side view of an embodiment. This embodiment includes a frame strip 400 of aluminum measuring 1/16″×½″ that can be attached to the cutters 402. This frame strip 400 can be attached to the upper edge of the cutters 402. However, in alternate embodiments, such frame 100 and/or frame strip 400 can be made of any known and/or convenient material. In some embodiments, a strip attachment 404, made of a steel piece of ¼″ square×6″ long can be used. This strip attachment 404 is attached to the frame strip 400 and also attached at the upper edge. In this embodiment, the slide attachment 404 should be placed on the 6″ side of the cutters. However, in some embodiments, the slide attachment 404 can be as long as the frame 406 around the cutters. Moreover, in further alternate embodiments, such slide attachment 404 can be made of any known and/or convenient material and such slide attachment 404 can be of any dimensions and/or the slide attachment 404 may not be present. The side view shows the cutter assembly 408.

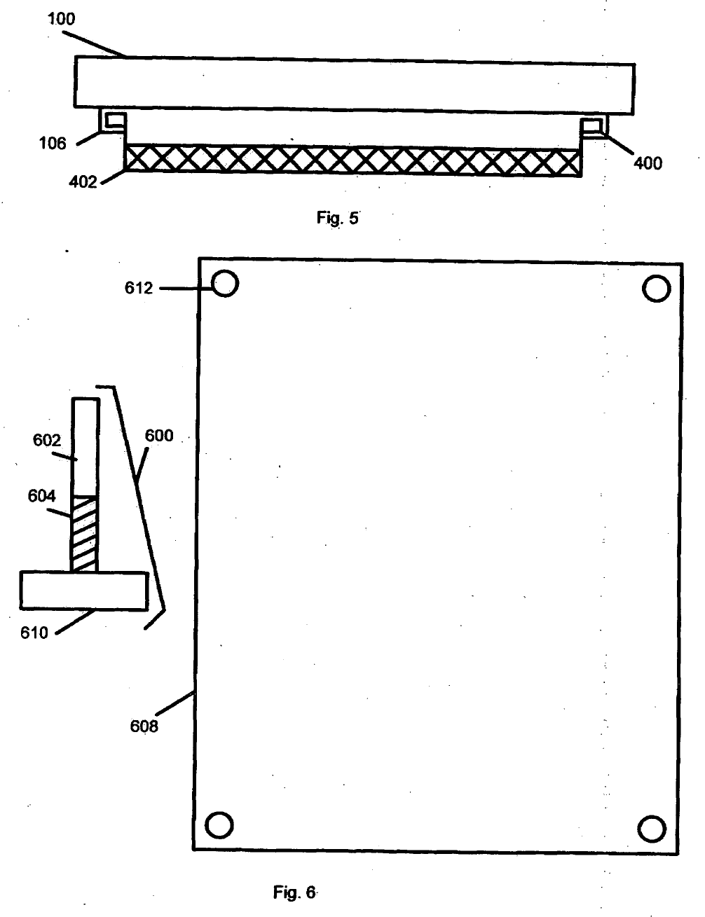

FIG. 5 shows the side view of the frame 100 and the channel 106. The cutters 402 and its frame strip 400 are shown as fitted into the channel 106.

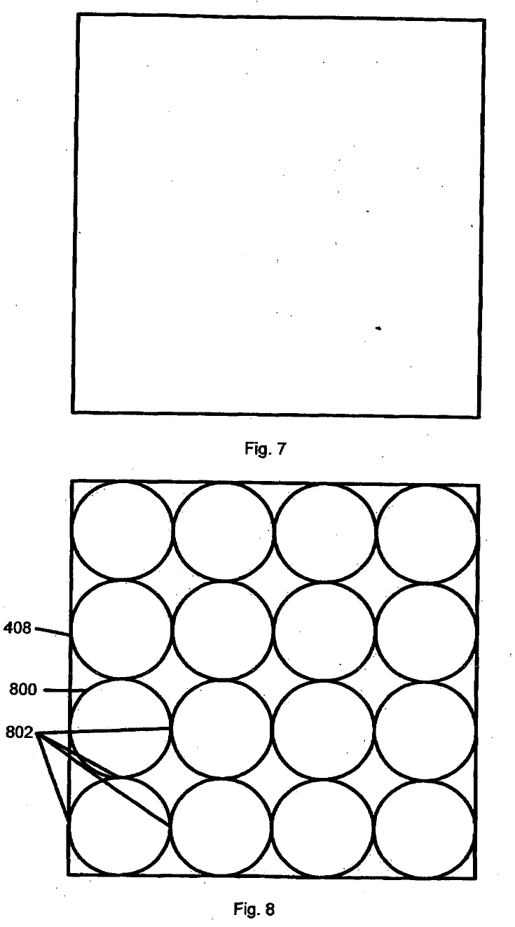

FIG. 6 shows an embodiment in which a plunger can be used attached to a Plunger Attachment 2100, that can be made up of a flat piece of lightweight, yet sturdy plastic, that can be set on posts 104 on top of the frame 100. When or if the cookie dough sticks in the cutters 402, such plunger 600 can be pressed down and can push the dough out of the cutters 402. The plunger can consist of a piece 602 with a spring 604 fitted within. The size of the plastic used to make the plunger 600 can be 6″×8½″. However, in alternate embodiments, such plunger 600 and plunger attachment 2100 can be of any known and/or convenient material and of any convenient geometric dimensions and/or such plunger attachment 2100 may not be present.

FIG. 6 shows such plunger 600 can be made of any known and/or convenient material. In some embodiments, a piece of acrylic sheet 608 cut to 6″×8½″ can be used for the underside of such plunger attachment 2100. The acrylic sheet 608 will have holes 612 in the corners to fit the posts 104 through. FIG. 6 also shows an alternate embodiment in which nylon/plastic pieces 610 can be attached to the underside of such plunger 600 that can be approximately 1¾″ long. In some embodiments, these pieces 610 should be at least ½″ wide and they should also be flat so as to not leave indents on the dough. However, in an alternate embodiment, the underside of such plunger 600 can be made of any known and/or convenient material and of any convenient geometric dimensions.

In some embodiments, a slow-drying epoxy can be used to assemble such pieces of the plunger attachment 600. However, in alternate embodiments, such pieces of the plunger attachment 600 can be assembled using any known and/or convenient fastening mechanism.

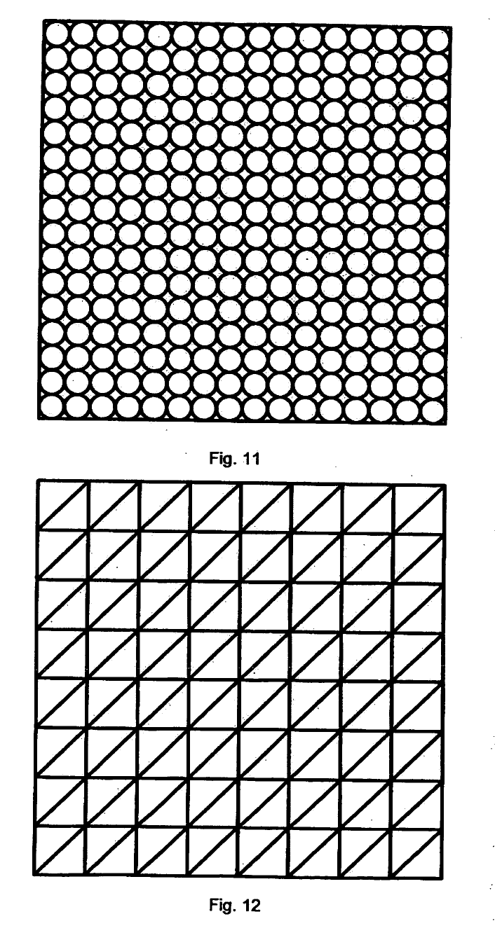

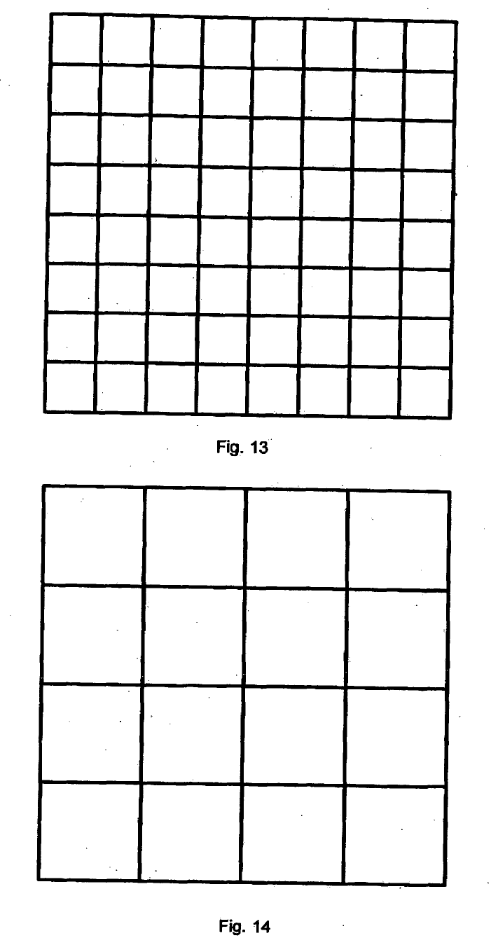

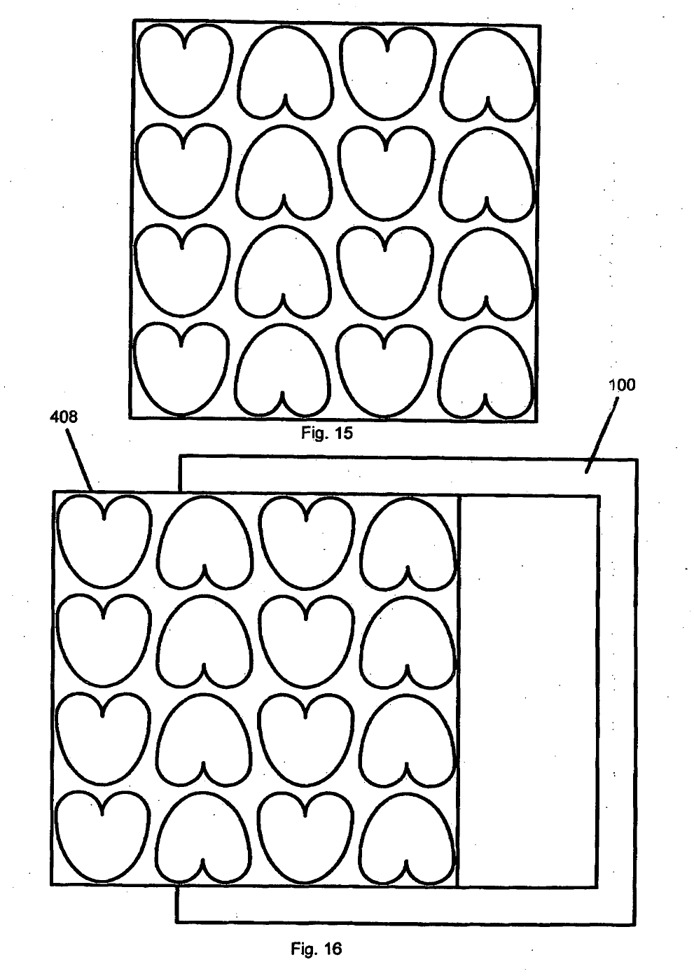

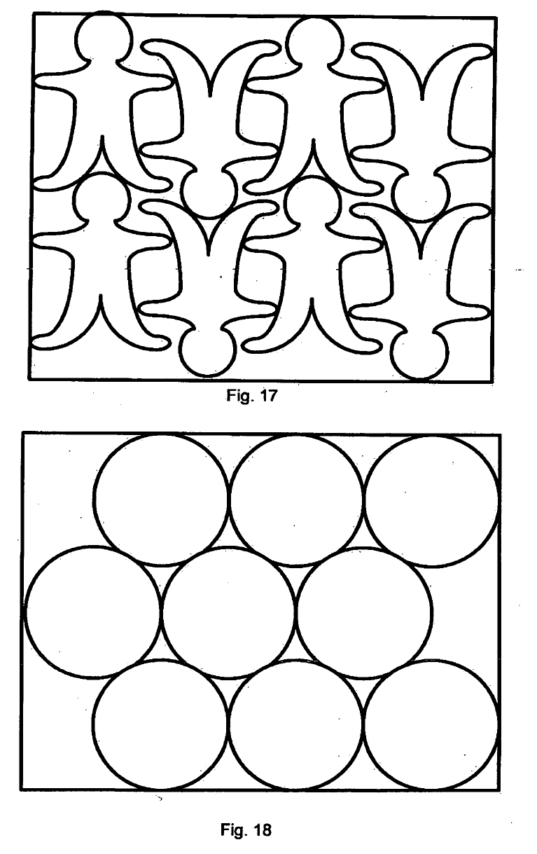

FIG. 7-FIG. 15 show alternate embodiments of the Multi-Cutter.

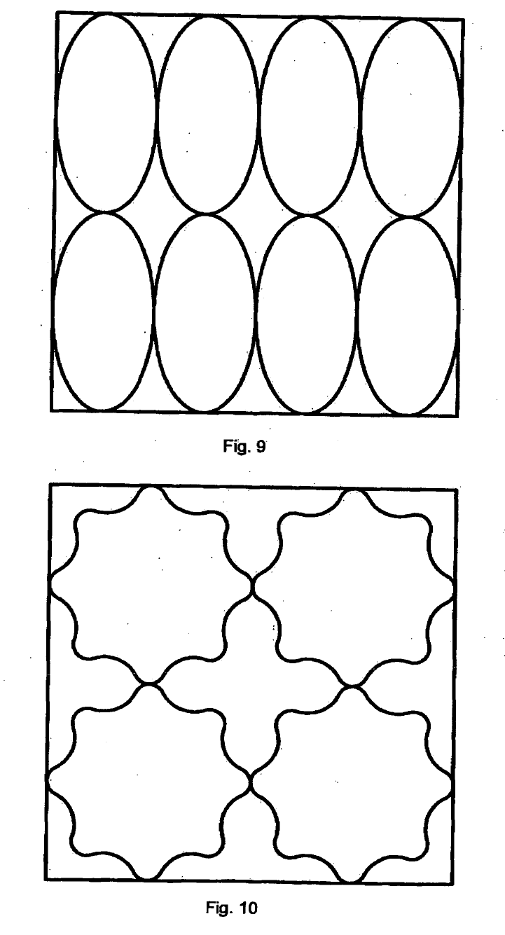

FIG. 8 shows an embodiment in which a Cutter Assembly 408 can be arranged into a 6″× up to 6″ shape cutters. Each of the cutters 800 can be attached to the others at number of points 802 to provide added strength and stability. However, in alternate embodiments as shown in FIG. 7-FIG. 15, any varied shapes of the cutters can be used and such shapes can be placed in any convenient dimensions.

FIG. 16 shows bottom view of the cutter assembly 408 sliding into the frame.

FIG. 17 and FIG. 18 show alternate embodiments of the Multi-Cutter.

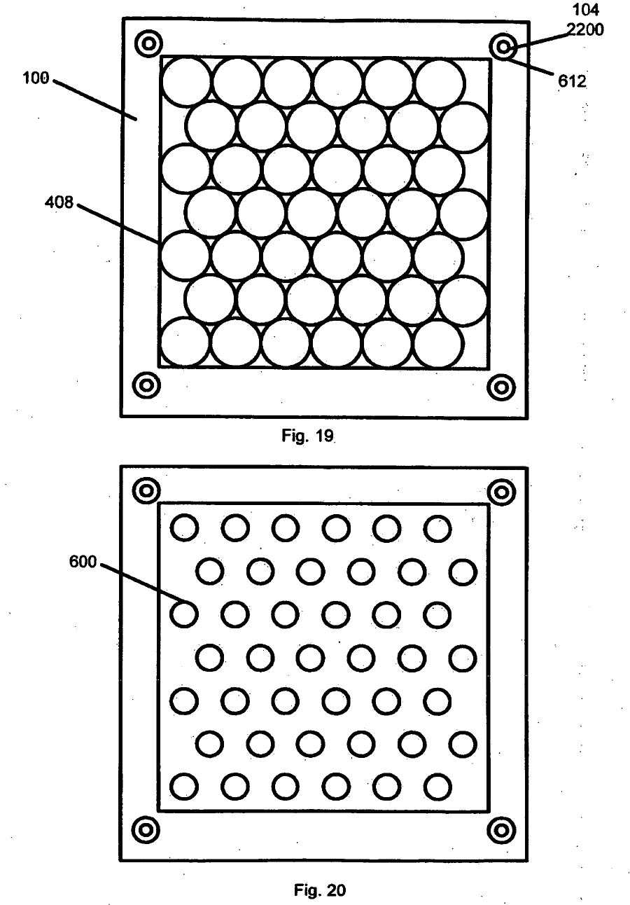

FIG. 19 shows a bottom view of an embodiment in which the cutter assembly 408 is attached to the frame 100. The cutters 402 are shown within the cutter assembly 408. The springs 604 within a plunger 600 are shown.

FIG. 20 shows a top view of an embodiment in which the cutter assembly 408 is attached to the frame 100. The tops of the plungers 600 are shown.

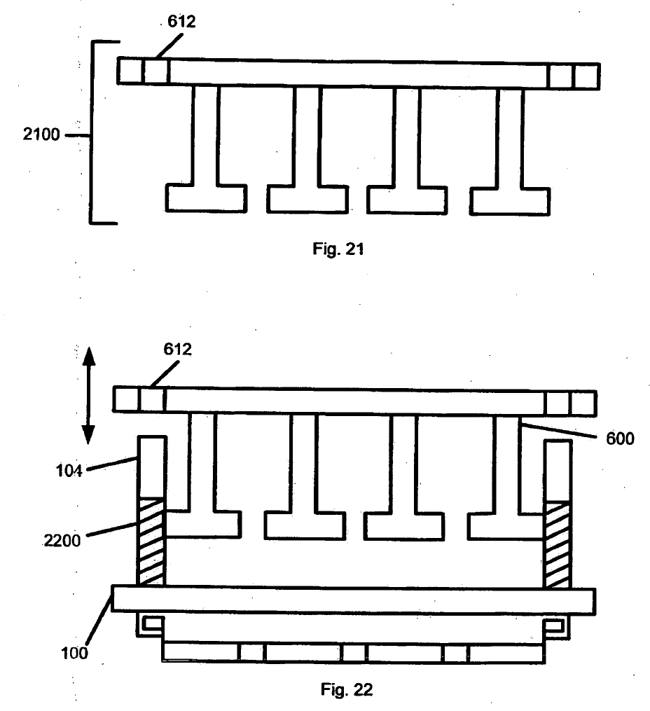

FIG. 21 shows an embodiment of the plunger attachment 2100 and plungers 600 without springs in them. The plunger attachment 2100 can be made of clear plastic so that the cutter assembly 408 is clearly visible. The holes 612 for the posts 104 can be placed 1⅜″ in from the 9″ side of the frame 100 and ½″ in from the 8″ side of the frame 100. Each post 104 can have a 1″ spring 604 on it to hold up the plunger attachment 2100 until it is needed. However, in alternate embodiment, such plunger attachment 2100 can be made of any known and/or convenient material and the posts 104 can be placed at any convenient geometric relationships to the frame 100.

In some embodiments, the plunger attachment 2100 can have ¼″×2″ stainless steel nut and bolts and such pieces can correspond to the shape of the cutters 402 so that the entire plunger attachment 2100 can be easily changed to match the cutter assembly 408. However, in alternate embodiments, such pieces of the plunger attachment 2100 can be made of any known and/or convenient material and can be of convenient or different shapes.

FIG. 22 shows an embodiment of the plungers 600 being fitted into the frame 100. The frame 100 has posts 104 with springs 2200 in them.

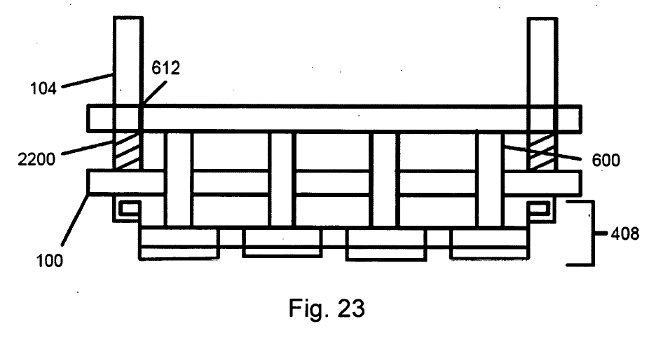

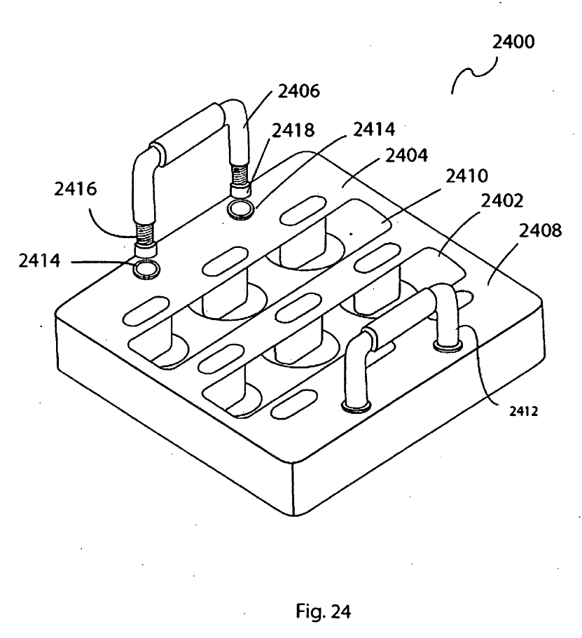

FIG. 23 shows an embodiment of the plungers 600 fitted into the frame 100. The frame 100 has posts 104 with springs 2200 in them. The plungers 600 are shown fitting through the cutter assembly 408.

FIG. 24 depicts an alternate embodiment of the multi-cutter assembly 2400. In the embodiment depicted in FIG. 24, the assembly is comprised of a cutter sheet 2402, a presser structure 2404 and a biasing handle 2406.

In the embodiment depicted in FIG. 24, the cutter sheet 2402 is comprised of a food-grade plastic. However, in alternate embodiments, the cutter sheet 2403 can be comprised of any known and/or convenient material capable of cutting dough and/or material of a desired consistency and toughness/hardness.

In the embodiment depicted in FIG. 24, the presser structure 2404 includes a support structure 2408 adapted to support and align the pressers 2410 with the cut outs of the cutter sheet 2402. In some embodiments, the pressers 2410 can be aligned will each of the cut outs of the cutter sheet 2402. However, in alternate embodiments the pressers 2410 can be aligned with only some of the cut outs of the cutter sheet 2402. In the embodiment depicted in FIG. 24, the presser structure 2404 can include one or more fixed gripping mechanisms 2412. However, in alternate embodiments the fixed gripping mechanism 2412 can be absent.

In the embodiment depicted in FIG. 24, the presser structure 2404 includes two penetrations 2414. The penetrations can be aligned to selectively engage at least a portion of the handle 2406. In some embodiment, the number of penetrations can be fewer or greater and in some embodiments the penetrations can be absent.

In the embodiment depicted in FIG. 24, the presser structure 2404 is comprised of a food-grade plastic. However, in alternate embodiments, the presser structure 2404 can be comprised of any known and/or convenient material capable.

In the embodiment depicted in FIG. 24, the assembly 2400 includes a handle 2406. In the embodiment depicted in FIG. 24, the handle 2406 can selectively engage the cutter sheet 2402 through the penetrations 2414 in the presser structure 2408. In some embodiments the handle 2406 can include biasing springs 2416, 2418 selected such that the presser structure 2404 and the cutter sheet 2402 move relative to each other within a desired range of motion. However, in alternate embodiments, the handle 2406 can include only one biasing spring 2416 or 2418 and/or the biasing springs may be absent. In still further alternate embodiments, the biasing springs 2416 2418 can be any known and/or convenient material and/or, matter, mechanism and/or construction that provides the desired bias.

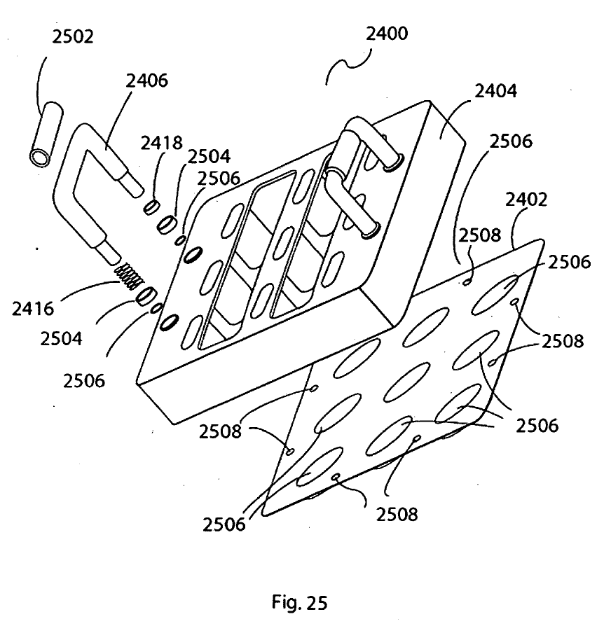

FIG. 25 depicts an exploded view of the assembly 2400 depicted in FIG. 24. In the embodiment depicted in FIG. 25, the handle can include a grip 2502. However, in alternate embodiments the grip 2502 can be absent.

In the embodiment depicted in FIG. 25, the handle 2406 can also include collets 2504 adapted to retain the springs 2416 2418 in desired positions. However, in alternate embodiments the collets 2504 can be absent.

In the embodiment depicted in FIG. 25, the handle 2406 can include magnetic components 2506 at one or more of the distal ends of the handle 2406. In some embodiments, the magnetic components 2506 can be magnets. However, in alternate embodiments the magnetic components 2506 can be magnetically attractive material. In still further alternate embodiments, the magnetic components 2506 can be absent.

In the embodiment depicted in FIG. 25, the cutter sheet 2402 can include magnetic components 2506 adapted to be magnetically attracted to the magnetic components 2506 in the handle 2402. In some embodiments the magnetic components 2506 associated with the cutter sheet 2402 can be selectively placed within recesses 2508 in the surface of the cutter sheet 2502. In the embodiment depicted in FIG. 25, the magnetic components 2506 can be bonded with the cutter sheet 2402. However, in alternate embodiments, the magnetic components 2506 can be contained within the cutter sheet 2402. In still further alternate embodiments, the cutter sheet 2402 and/or portions of the cutter sheet 2402 can be comprised of a magnetically attractive material and the magnetic components 2506 and/or recesses 2508 can be absent.

In operation, the cutter sheet 2402 can be aligned with the material to be cut and pressed into the material. The presser structure 2404 can the be aligned with the cutting sheet 2402 and the handle can be used to provide additional pressure to the cutter sheet 2403. The magnetic components 2506 of the cutter sheet 2402 and the handle 2406 can then engage and the cutter sheet 2402 can be lifted using the handle 2406 while the pressers 2410 of the presser structure 2404 make contact with the cut out material to ensure that the desired cut out shapes remain on the cutting surface below the cutting sheet 2402.

It should be understood that the particular embodiments described above are only illustrative of the principles of the present invention, and various modifications could be made by those skilled in the art without departing from the scope and spirit of the invention. Thus, the scope of the present invention is limited only by the claims that follow.

What is claimed is:

1. An apparatus comprising:
a frame;
a cutter assembly; and
a plunger attachment;
wherein said frame, said cutter assembly and said plunger are configured to cut multiple cookie shapes.
